(19) United States
(12) Patent Application Publication
(10) Pub. No.: US 2009/0173425 A1
(43) Pub. Date: Jul. 9, 2009

(54) Liner For Providing a Scent

(76) Inventor: Lynne A. Sammons, Cypress, TX (US)

Correspondence Address: BUCHE & ASSOCIATES, P.C., 875 PROSPECT, SUITE 305, SUITE 205, LA JOLLA, CA, 92037, US

(21) Appl. No.: 12/350,058

(22) Filed: Jan. 7, 2009

Related U.S. Application Data
(60) Provisional application No. 61/019,989, filed on Jan. 9, 2008.

(51) Int. Cl. B32B 5/02; B32B 37/14

(52) U.S. Cl. 156/60; 442/96; 428/40.1; 428/41.4

(57) ABSTRACT

The present application is directed to a liner providing a scent. The liner comprises a fabric defining a first surface of the liner; an adhesive defining a second surface of the liner; and a fragrance infused within the fabric; whereby the first and second surfaces comprise substantially similar surface areas.

### CROSS-REFERENCE TO RELATED APPLICATIONS

The application is entitled to the benefit of the filing date of the prior-filed provisional application No. 61/019,989, filed on Jan. 9, 2008.

### STATEMENT REGARDING FEDERALLY SPONSORED RESEARCH OR DEVELOPMENT

Not applicable.

### FIELD OF THE APPLICATION

The application relates generally to a article for emitting a volatile agent to be smelled or otherwise inhaled by individuals.

### BACKGROUND

Various products exist that provide selected chemical volatile agents in airborne form for inhalation and/or scent sensation. However, no one product provides adaptability to various environments, ease of storage, ease of transport, disposability, reusability, aesthetic qualities, resistance to environmental conditions, hygiene related protection, comfort, virtual invisibility when necessary, among others while providing a scent for prolonged periods of time. A need exists for such an item.

### SUMMARY

The present application is directed to a liner providing a scent. The liner comprises a fabric defining a first surface of the liner; an adhesive defining a second surface of the liner; and a fragrance infused within the fabric; whereby the first and second surfaces comprise substantially similar surface areas.

The present application is also directed to a liner comprising about 56.5% by weight of a fabric; about 14.0% by weight of a polyethylene film material; about 5.00% by weight of adhesive; about 24.50% by weight of silicone treated release paper; and about 0.50% by weight of fragrance; whereby the fabric defines a first surface of the liner and the silicone treated release paper defines a second surface of the liner.

The present application is also directed to a liner comprising a first layer comprising a synthetic fabric of about 9.50 gsm and a cellulosic material of about 47.0 gsm; a second layer comprising a polyethylene film material of about 14.0 gsm; a third layer comprising an adhesive; and a fragrance infused within at least the first layer; wherein the liner comprises about 24.5% by weight of said adhesive.

The present application is also directed to a method of localizing a scent of a particular strength, comprising the steps of (1) obtaining a liner comprising (a) a scent absorbing amount of a non-woven fabric defining a first surface, (b) an adhesive defining a second surface, (c) a fragrance effective to produce a scent, the fragrance infused within the non-woven fabric and comprising about 0.60% by weight of said liner, whereby the first and second surfaces comprise substantially similar surface areas; and (2) adhering substantially the entire second surface to a target surface.

### BRIEF DESCRIPTION OF THE FIGURES

So that the manner in which the features and advantages of the invention, as well as others will become apparent and may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 illustrates a perspective view of a first embodiment of the liner.

FIG. 2 illustrates a perspective view of a second embodiment of the liner.

FIG. 3 illustrates a detailed perspective view of a third embodiment of the liner.

FIG. 4 illustrates a perspective view of the liner including separation of the backing member from the adhesive.

FIG. 5 illustrates a perspective view of the liner, including a partial phantom image thereof, as used in conjunction with a pillow and pillow case.

### BRIEF DESCRIPTION

It has been found that a liner article may be configured to provide a scent to one or more individuals. It has also been found that a liner article may be configured to provide a scent to one or more individuals for a specified period of time as determined by the materials of construction and the fragrance infused therein. It has further been found that a scent absorbing fabric, in conjunction with an adhesive material, may be configured to localize a scent near a target surface, including target surfaces flexible in nature. In addition, when used in conjunction with an individual's bedding, the liner article may provide a sense of invisibility not being detectable by the user, nor upsetting the individual's natural relationship with the bedding item(s). Likewise, an odor permeable barrier may be applied between the liner article and the user as a means for reducing the strength of the scent sensed by the user. Such a desirable achievement has neither been made, nor previously considered possible; accordingly, the liner and method of this application measure up to the dignity of patentability and represent a patentable concept.

Before describing the invention in detail, it is to be understood that the present liner and method are not limited to particular embodiments. It is also to be understood that the terminology used herein is for the purpose of describing particular embodiments only, and is not intended to be limiting. As used in this specification and the appended claims, the term “scent” refers to a volatilized chemical compound that people perceive by the sense of olfaction. Herein, the term scent may be used interchangeably with terms including “smell,” “odor,” and “aroma.” The term “scent” is not limited to pleasant or savory smell but also encompasses all known odors, whether agreeable or offensive, whether directed to humans or other life forms including animals, insects, spiders, bacteria and the like. Herein, the terms “perfume,” “perfume composition,” “fragrance,” and “fragrance composition” refer to the starting chemical volatile agent to be added to a liner for producing a desired scent to be emitted there from. Herein, the term “aromatherapy” refers to the therapeutic use of a liner infused with one or more volatile oils distilled from plants. The phrase “non-woven material” refers to scent absorbing fabrics that are neither woven nor knitted. Herein, “to rest” means to sleep or relax in a substantially stationary state or position. The terms “flexible” and “bendable” may be used interchangeably herein. The term “bedding” refers to items including, but not necessarily limited to sheets, pillows, comforters, and pillow cases.

In one aspect, the application provides a scented liner for bedding.

In another aspect, the application provides a disposable scented pillow liner.

In another aspect, the application provides a durable scented liner for bedding configured for continual use once the liner's original scent has faded.

In another aspect, the application provides a pillow liner that may be reinfused with a scent periodically over time.

In another aspect, the application provides a scented liner including an adhesive for releasably attaching the liner to a surface.

In another aspect, the application provides a scented liner that is thin, and soft, yet is relatively sturdy and resistant to excessive ripping and tearing.

In another aspect, the application provides a scented liner that may be adhered to a flexible surface.

In another aspect, the application provides a liner that may be infused with a particular scent as desired.

In another aspect, the application provides a liner for localized use whereby the liner may be infused with a particular scent that diffuses throughout a prescribed area.

In another aspect, the application provides a liner that may be infused with one or more volatile chemical compounds for therapeutic applications as desired.

In another aspect, the application provides an infusible liner constructed from non-woven material.

In another aspect, the application provides a liner constructed from non-woven material that may be infused with a particular amount of fragrance to produce a scent effective to persist for a predetermined period of time.

In another aspect, the application provides a liner constructed from non-woven material that may be infused with one or more volatile substances for aromatherapy purposes.

In another aspect, the application provides a multi-layered liner constructed from non-woven material that may be infused with a particular amount of fragrance to produce a scent effective to persist for a predetermined period of time.

In another aspect, the application provides a multi-layered liner constructed from non-woven material that may include one or more liquid impermeable layers.

In another aspect, the application provides an infusible liner constructed from non-woven material that may be heated or cooled prior to use.

In another aspect, the application provides a liner constructed from non-woven material that may be employed in medical hygiene applications.

In another aspect, the application provides a liner that may be reinfused with a fragrance other than the fragrance that was originally emitted there from.

In another aspect, the application provides a liner for providing a scent of a particular strength, whereby the scent may be reduced in strength by applying an odor permeable barrier between the liner and the user as desired.

### Discussion of the Liner and Method of Use Thereof

To better understand the novelty of the liner and method of use thereof, reference is hereafter made to the accompanying drawings. With reference now to a simplified illustration of the invention as provided in FIG. 1, a liner 10 is provided comprising a scent absorbing fabric 12 defining a first surface of the liner 10, an adhesive composition 14 (hereafter “adhesive”) disposed along the opposite side of the fabric 12 and defining a second surface of the liner 10, and a fragrance infused within the fabric 12.

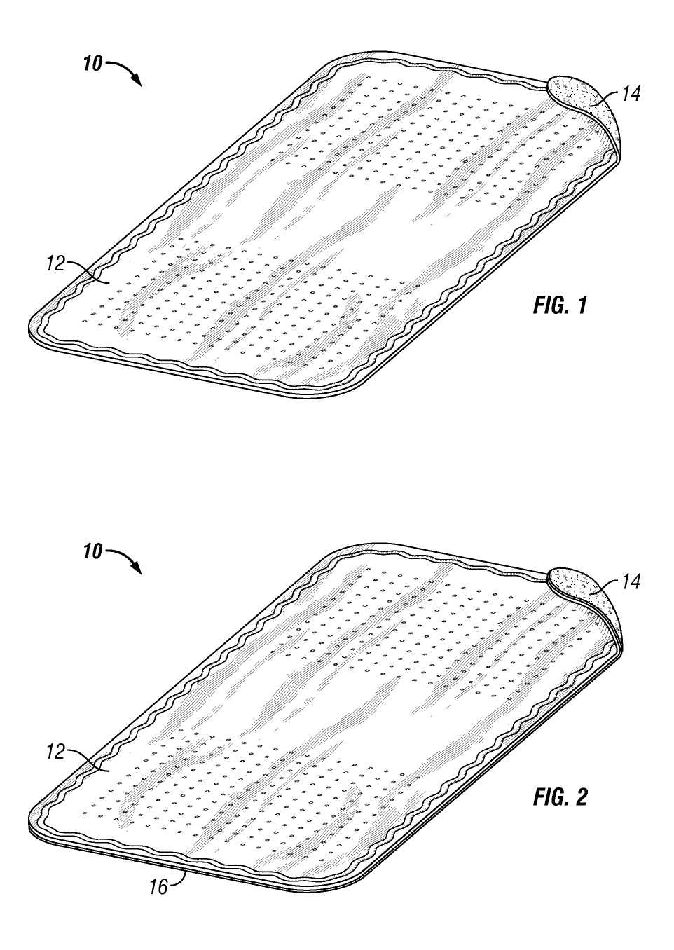

In another embodiment, the liner 10 may further comprise a support film 16 disposed along one side of the fabric 12 and configured to maintain the integrity of the fabric 12 during use of the liner 10. In this embodiment, an adhesive 14 may be disposed along the opposing side of the support film 16 as illustrated in FIG. 2.

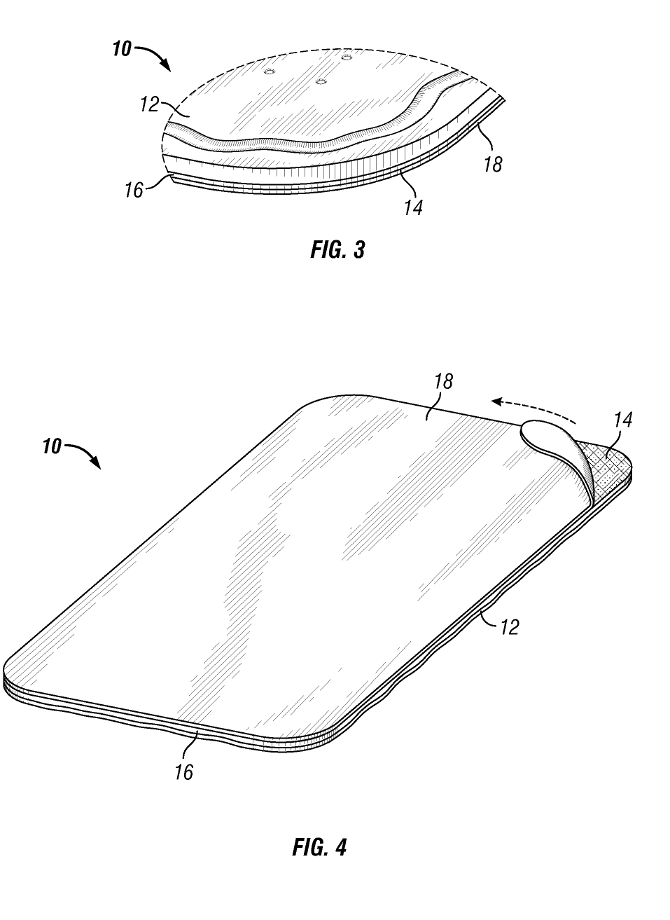

In yet another embodiment as shown in the simplified illustration of FIG. 3, the liner 10 may further comprise a backing member 18 defining a second surface of the liner 10, wherein the adhesive 14 is disposed or sandwiched between either (1) the fabric 12 and the backing member 18, or between (2) the support film 16 and the backing member 18—depending on the desired configuration of the liner 10. With attention to FIG. 4, the backing member 18 is suitably releasably adhered to the adhesive 14 surface in a manner effective for the backing member 18 to be easily peeled or otherwise removed from the liner 10 to expose the adhesive 14 prior to use of the liner 10.

In general, a suitable liner 10 comprises the following configuration:
(1) A First Layer comprising a Scent Absorbing Fabric
(2) A Second Layer comprising a Support Film
(3) A Third Layer: comprising an Adhesive
(4) An Optional Fourth Layer comprising a Backing member
   It should be noted that during liner 10 usage, the scent absorbing fabric 12 acts as a top outer layer, while the adhesive 14 acts as a bottommost layer releasably attached to a target surface. It should also be noted that the liner 10 may be built to scale depending on the desired application. Exemplary configurations and dimensions thereof are discussed in more detail below.

Scent Absorbing Fabric Materials

In one embodiment, the liner 10 may comprise a scent absorbing woven fabric 12. In a particularly advantageous embodiment, the liner 10 comprises a scent absorbing non-woven fabric 12 formed by bonding and/or interlocking individual fibers via mechanical means, chemical means, thermal means, solvent means, and combinations thereof. In one embodiment, the fabric 12 may be constructed from a single fiber type. In another embodiment, the fabric 12 may be constructed from two or more fiber types.

Herein, suitable non-woven fabrics 12 include fibers made from natural materials, synthetic materials, and combinations thereof. Suitable natural materials include, but are not necessarily limited to cellulosic materials, natural polyamides, and combinations thereof. Suitable synthetic materials include, but are not necessarily limited to polyesters, polypropylenes, synthetic polyamides, and combinations thereof. A suitable cellulosic material includes, but is not necessarily limited to wood pulp. Exemplary natural polyamides include, but are not necessarily limited to wool and silk. Exemplary synthetic polyamides include, but are not necessarily limited to nylons.

In an embodiment comprising fibers of two or more materials, the fiber types may be bonded and/or interlocked as described above. In the alternative, a single fiber type may be bonded and/or interlocked separately to form a first layer, while a second fiber type may be bonded and/or interlocked separately to form a second layer—the two layers thereafter being bonded and/or interlocked or otherwise entangled to form the complete fabric 12. In one suitable embodiment, the fabric 12 may comprise a single layer of synthetic fibers. In another suitable embodiment, the fabric 12 may comprise a single layer of natural fibers. In a particularly advantageous embodiment, the fabric 12 may comprise a combination of polyester fibers and virgin wood pulp fibers—either formed as one layer or as two separate layers as described above.

Desirably, the fabric 12 comprises a thickness up to about 0.05 of an inch (about 1.25 mm). In an embodiment comprising a first layer of synthetic fibers and a second layer of wood fibers, the first layer comprises a thickness of about 0.01 of an inch (about 0.25 mm), while the second layer comprises a thickness of about 0.04 of an inch (about 1.0 mm). In addition, the fabric 12 of this application may comprise a weight up to about 110 gsm—either a synthetic material alone, or in combination with a cellulosic material. In one particularly advantageous embodiment, the fabric 12 is comprised of (1) a first layer of polyester fibers having a weight of about 18.0 gsm and a thickness of about 0.01 of an inch (about 0.25 mm), and (2) a second layer of airlaid paper having a weight of about 90.0 gsm and a thickness of about 0.04 of an inch (about 1.0 mm).

Support Film

As stated previously, a support film 16 may be joined to the fabric 12 to maintain the integrity of the fabric 12 during use of the liner 10. A suitable support film 16 may be bonded to a surface of the fabric 12 as desired, whether via mechanical means, chemical means, thermal means, solvent means, and combinations thereof. In a particularly advantageous embodiment, a support film 16 is bonded to a second surface of the fabric 12 covering substantially an entire side of the fabric 12. In like manner, substantially the entire non-bonded side of the support film 16 may be covered or coated over with an adhesive 14 to provide an attachment means of the liner 10 to a target surface.

The support film 16 may be constructed from any number of materials that have breathable or vapor permeable attributes, and/or a liquid permeable attributes effective for the passage of air and/or liquids there through. In addition, the support film 16 may be tear resistant and moisture resistant as desired. Likewise, the support film 16 may be constructed from one or more materials effective for hygiene critical applications. A suitable support film 16 may also be configured to inhibit growth of potentially harmful bacteria, mold, and mildew.

Although various materials may be incorporated, such as rubbers and plastics, a suitable support film 16 includes a polyethylene film having a thickness from about 0.001 to about 0.02 of an inch (about 0.025 to about 0.5 mm), and a weight up to about 30.0 gsm. In a particularly advantageous embodiment, the polyethylene film has a thickness of about 0.01 of an inch (about 0.25 mm) and a weight of about 25.0 gsm.

Adhesive

Suitable adhesives 14 may include pressure-sensitive adhesives capable of securely adhering a liner 10 to a target surface, while permitting removal of the liner 10 there from as desired. Likewise, a suitable adhesive 14 may include any pressure-sensitive adhesive capable of securely adhering a liner 10 to a target surface while also being releasable from any backing member 18 attached thereto. For convenience, it may be advantageous to employ adhesive formulations already known in the art of disposable articles. For example, hot melt adhesives comprised of conventional molecular weight block copolymers including for example, ethylene/vinyl acetate copolymers, isotactic or atactic polypropylene, styrene-butadiene, styrene-isoprene, or styrene-ethylene-butylene A-B-A or A-B-A-B block copolymers. In a particularly advantageous embodiment, the adhesive 14 comprises colophony based glue as commercially available from Henkel Corporation, Henkel Consumer Goods, Inc., located in Irvine, Calif.

Herein, a suitable amount of adhesive 14 includes an amount effective to maintain the liner 10 in a secured position against a target surface for a desired period of time before naturally unattaching itself there from, or an amount effective to maintain the liner 10 in a secured position against a target surface against external contact during use of the liner 10. As stated above, substantially the entire surface of either the fabric 12 or support film 16 may be coated with an adhesive 14. Alternatively, an adhesive 14 may be coated onto the fabric 12 or support film 16 in separate sections effective to secure the liner 10 to a target surface. In an advantageous embodiment, the perimeter of the surface of the fabric 12 or support film 16 is coated with an adhesive effective to maintain the outer edge of the liner 10 in contact with a support surface during use of the liner 10.

Although the particular amount of adhesive used may depend on the desired use of the liner 10, as used with a liner 10 as described herein, the adhesive 14 suitably has a thickness from about 0.0001 of an inch to about to about 0.001 of an inch (about 0.00254 mm to about 0.0254 mm), ranging in weight from about 10 gsm to about 40 gsm.

Liner Backing Member

To protect against undesirable adhesion and/or contamination of the liner 10 prior to actual use, a backing member 18 may be incorporated to cover and/or seal the adhesive 14 prior to use of the liner 10. In one embodiment, the backing member 18 may include the actual packaging used to enclose and/or seal the liner 10 from the environment. Such packaging may include the type commonly used in the retail market for disposable articles. In this embodiment, the inner surface of the packaging is coated with one or more materials effective for the removal of the liner 10 from the inner surface of the packaging.

In the embodiment depicted in FIG. 4, the backing member 18 may include a releasable sheet like material that is peelable from the adhesive 14 surface of the liner 10. The backing member 18 may be constructed from one or more materials effective for the backing member 18 to adhere with sufficient tenacity to an adhesive 14 to remain in place but which can also be readily separated from the adhesive 14 prior to use. In this embodiment, a suitable backing member 18 may include release paper coated with one or more materials for easy release of the backing member 18 from the adhesive 14. In a particularly advantageous embodiment, the backing member 18 is comprised of a paper coated with silicone, i.e., silicone treated paper.

As described herein, the backing member 18 of FIG. 4 has a thickness from about 0.001 of an inch to about to about 0.003 of an inch (about 0.04 mm to about 0.08 mm), including a weight up to about 50 gsm. In a particularly advantageous embodiment, the backing member 18 has a thickness of about 0.002 of an inch (about 0.06 mm), and a weight of about 45 gsm.

Fragrances

Although practically any fragrance may be infused into the fabric 12, suitable fragrances include encapsulated and/or microencapsulated volatile chemical compounds of natural origin, synthetic origin, and combinations thereof. More particularly, suitable fragrances include those encapsulated and/or microencapsulated fragrances including, but not necessarily limited to the following substances: (1) alcohol(s) other than ethanol, (2) aldehyde(s), (3) ester(s), (4) ketone(s), (5) terpenes, (6) phenols, (7) oxides, and combinations thereof. It is herein contemplated that the above listed substances may be derived from natural sources. However, once any chemical composition is identified, the same composition, however complex, can in most cases be duplicated by organic synthesis.

In one exemplary embodiment, the fabric 12 may be infused with one or more fragrances necessary to provide a pleasant scent to an individual. In another exemplary embodiment, the fabric 12 may be infused with one or more fragrances necessary to treat symptoms related to stress headaches, colds, nasal congestion, and combinations thereof. During continued use of a particular liner 10, as the fragrance volatilizes the fragrance may be readily inhaled by a user for a intended therapeutic effect.

Although persons of ordinary skill in the art may make use of varying types of the above listed substances, a more thorough discussion of fragrances incorporating each of the above substances follows: (1) Alcohols, as provided in essential oils, tend to have good antiseptic and anti-viral properties as well as uplifting qualities. Exemplary alcohol containing oils include linalol (a major constituent of lavendar) and citronellol (found in rose, lemon, eucalyptus and geranium); (2) Aldehydes are typical constituents of lemon scented fragrances and generally have sedating but uplifting qualities; (3) Esters are among the most common compounds found in essential oils. Esters have fungicidal and sedative properties; (4) Suitable ketone containing substances include jasmine and sweet fennel, which may be incorporated to help with problems affecting the upper respiratory tract; (5) Suitable terpenes include for example, limonene, an anti-viral agent found in most of citrus oils, pinene, which is a strong antiseptic found in pine, and chamazulene, found in chamomile, possesses anti-inflammatory and bacterial properties; (6) Phenols are powerful antibacterials. Upon contact, they may warm the skin and stimulate blood flow of an individual. Phenol containing sources include for example, basil, clove, thyme and oregano oils; (7) Suitable oxides include those found in oils of the camphoraceous nature and tend to possess expectorant effects. Exemplary oxides include rosemary, eucalyptus and tea tree.

It is also contemplated herein that various components of the liner 10 may comprise one or more materials having one or more of the following properties: a flame retardant, a water-proofing agent, an alcoholic-proofing agent, an oil-proofing agent, an anti-static agent, moisture absorption, and air-breathing ability—while possessing no abrasive noise during use. In addition, the fabric 12 may comprise an aesthetically pleasing pattern of depressed areas upon an upper surface as depicted in FIGS. 1-3, 5. The liner 10 may also comprise a colorant (e.g., a pigment) as desired. Since the present liner 10 is suitably constructed from flexible materials, a target surface need not be flat or smooth in order to apply the liner 10 thereto.

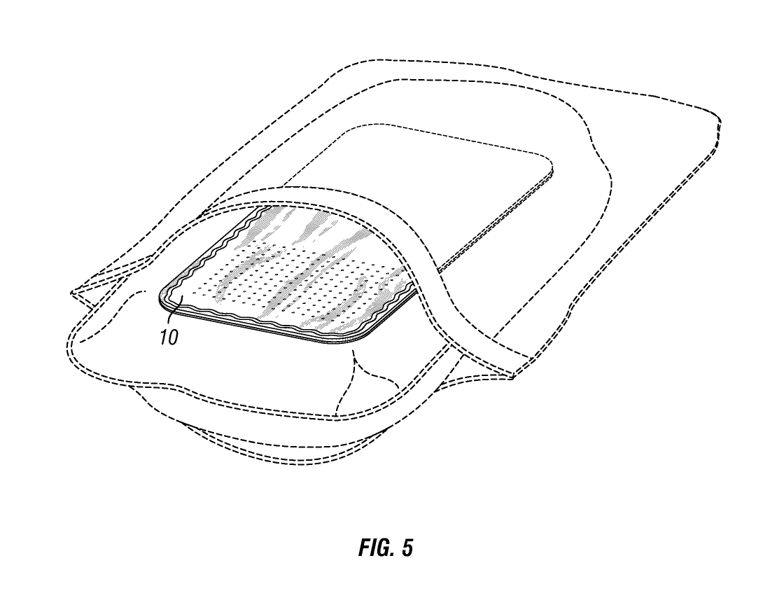

Persons of ordinary skill in the present art will appreciate that the liner 10 may be used in various environments and for various applications. In one apposite embodiment, a scent may be localized to the benefit of an individual at rest by adhering the liner 10 to bedding, a surface of a head board, a night stand, a lamp, a chair or the like, and other items situated near the nose of a resting individual. In an implementation of the liner 10 acting as a pillow liner, the adhesive 14 side of the liner 10 may be applied to the surface of a pillow as shown in FIG. 5. Thereafter, the pillow may be placed within a pillow case. It should be noted that the strength of the scent emitted from the liner 10 may be determined, controlled or otherwise dictated by the material used to cover the liner 10. For example, a light weight vapor permeable pillow case may be used in instances where an individual wishes to experience up to about full strength of the scent of the liner 10, and vice versa.

In another implementation, a particular amount of a fragrance may be infused into the liner 10 once the strength of the scent emitted there from is undetectable by the user, or otherwise weakened beyond desired use thereof. In this instance, an individual may simply reinfuse a desired amount of fragrance into the fabric 12. Thus, an advantageous feature of the present invention involves the ability to calculate the desired strength of a particular scent prior to infusing the fragrance into the liner 10 as determined by both the liner materials and fragrance substances to be used.

It is also contemplated that the present liner 10 be used in places other than the home or office as limited only by one's imagination. For example, an individual may adhere a liner 10 to the surface of his/her seat while traveling by car, bus, airplane, train, etc. In addition, the liner 10 may be adhered to a movie cinema seat and the like. Thereafter, the liner 10 may be removed from the target surface and disposed of or transported for future use.

The invention will be better understood with reference to the following non-limiting examples, which are illustrative only and not intended to limit the present invention to a particular embodiment.

### EXAMPLE 1

In one non-limiting example, a scented liner 10 was provided having the following characteristics:

TABLE 1

| Dimensions | |
|---|---|
| Width | about 12 inches (about 30.5 cm) |
| Height | about 6¼ inches (about 15.9 cm) |
| Thickness | about 0.06 inches (about 0.15 cm) |
| Weight | about 0.35 ounces (about 10.0 grams) |

| Layer | Material | % by Weight |
|---|---|---|
| Top Layer | Non woven fabric | 19.50 |
| Second Layer | Airlaid cellulosic layer | 43.50 |
| Third Layer | Polyethylene film | 18.50 |
| Fourth Layer | Adhesive material | 9.50 |
| Fifth Layer | Release paper | 8.00 |
| | Adhesive (colophony) | 1.00 |

### EXAMPLE 2

In another non-limiting example, an unscented liner 10 was provided having the following characteristics:

TABLE 2

| Dimensions | |
|---|---|
| Width | about 12 inches (about 30.5 cm) |
| Height | about 6¼ inches (about 15.9 cm) |
| Thickness | about 0.06 inches (about 0.15 cm) |
| Weight | about 0.35 ounces (10.0 grams) |

| Layer | Material | % by Weight |
|---|---|---|
| Top Layer | Non woven fabric | 9.50 |
| Second Layer | Airlaid cellulosic layer | 47.00 |
| Third Layer | Polyethylene film | 14.00 |
| Fourth Layer | Adhesive material | 5.00 |
| Fifth Layer | Release paper | 24.50 |

### EXAMPLE 3

In another non-limiting example, an unscented liner 10 having a total weight of 0.35 ounces (10.0 grams) was provided having the following characteristics:

TABLE 3

| Material | Weight (gsm) | % by Weight |
|---|---|---|
| Non woven fabric | 18 | 9.50 |
| Airlaid cellulosic layer | 90 | 47.00 |
| Polyethylene film | 25 | 14.00 |
| Release paper | 45 | 24.50 |
| Adhesive material | | 5.00 |

### EXAMPLE 4

In another non-limiting example, a liner 10 was provided including a fragrance having the characteristics as described in the following table:

TABLE 4

| | Component % |
|---|---|
| Chemical Class | |
| Alcohols (non-ethanol) | 53.20 |
| Aldehydes | 8.73 |
| Esters | 32.67 |
| Ketones | 0.88 |
| Solvents | 0.00 |
| Miscellaneous Constituents | 4.52 |
| Chemical Origin | |
| Natural | 1.00 |
| Synthetic | 99.00 |

### EXAMPLE 5

In another non-limiting example, a liner 10 was provided including a fragrance having the characteristics as described in the following table:

TABLE 5

| | Component % |
|---|---|
| Chemical Class | |
| Alcohols (non-ethanol) | 24.30 |
| Aldehydes | 0.00 |
| Esters | 0.10 |
| Ketones | 0.00 |
| Solvents | 73.10 |
| Miscellaneous Constituents | 2.50 |
| Chemical Origin | |
| Natural | 100.00 |
| Synthetic | 0.00 |

### EXAMPLE 6

In another non-limiting example, a liner 10 was provided including a fragrance having the characteristics as described in the following table:

TABLE 6

| | Component % |
|---|---|
| Chemical Class | |
| Alcohols (non-ethanol) | 10.54 |
| Aldehydes | 2.75 |
| Esters | 14.79 |
| Ketones | 2.64 |
| Solvents | 56.00 |
| Miscellaneous Constituents | 13.28 |
| Chemical Origin | |
| Natural | 1.06 |
| Synthetic | 98.94 |

### EXAMPLE 7

In another non-limiting example, a liner 10 was provided including a fragrance having the characteristics as described in the following table:

TABLE 7

| | Component % |
|---|---|
| Chemical Class | |
| Alcohols (non-ethanol) | 15.68 |
| Aldehydes | 5.20 |
| Esters | 21.04 |
| Ketones | 3.12 |
| Solvents | 48.08 |
| Miscellaneous Constituents | 6.88 |
| Chemical Origin | |
| Natural | 0.64 |
| Synthetic | 99.36 |

### EXAMPLE 8

In another non-limiting example, a liner 10 was provided including a fragrance having the characteristics as described in the following table:

TABLE 8

| | Component % |
|---|---|
| Chemical Class | |
| Alcohols (non-ethanol) | 30.70 |
| Aldehydes | 0.15 |
| Esters | 11.70 |
| Ketones | 14.75 |
| Solvents | 36.20 |
| Miscellaneous Constituents | 6.50 |
| Chemical Origin | |
| Natural | 0.20 |
| Synthetic | 99.80 |

### EXAMPLE 9

In another non-limiting example, a liner 10 was provided including a fragrance having the characteristics as described in the following table:

TABLE 9

| | Component % |
|---|---|
| Chemical Class | |
| Alcohols (non-ethanol) | 70.30 |
| Aldehydes | 0.00 |
| Esters | 0.00 |
| Ketones | 0.00 |
| Solvents | 0.00 |
| Miscellaneous Constituents | 29.70 |
| Chemical Origin | |
| Natural | 100.00 |
| Synthetic | 0.00 |

Nonetheless, it is contemplated that other chemical percentages and compositions may be infused into the fabric 12 depending on the particular fragrance desired as well as the desired strength of the fragrance scent.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

I claim:

1. A liner providing a scent, comprising:
a fabric defining a first surface of the liner;
an adhesive defining a second surface of the liner; and
a fragrance infused within the fabric;
whereby the first and second surfaces comprise substantially similar surface areas.

2. The liner of claim 1 further comprising a backing member releasably adhered to the second surface.

3. The liner of claim 2 wherein the surface of the backing member releasably adhered to said second surface comprises a substantially similar surface area as said second surface.

4. The liner of claim 2 wherein the backing member comprises a sealable package member.

5. The liner of claim 2, wherein the backing member comprises release paper.

6. The liner of claim 5, wherein the release paper is a silicone treated release paper.

7. The liner of claim 1, wherein the fabric is a scent absorbing non-woven fabric.

8. The liner of claim 1 including a substantially uniform second surface.

9. The liner of claim 1 further including a support film located between the fabric and adhesive, the support film comprising a polyethylene film.

10. The liner of claim 7 wherein the fabric comprises at least about 50% the total weight of the liner.

11. The liner of claim 7, wherein the fabric comprises a combination of synthetic fibers and wood fibers.

12. The liner of claim 1, wherein the liner is effective to adhere to flexible surfaces.

13. The liner of claim 1 comprising about 1.00% by weight of said fragrance.

14. A liner comprising:
about 56.5% by weight of a fabric;
about 14.0% by weight of a polyethylene film material;
about 5.00% by weight of adhesive;
about 24.50% by weight of silicone treated release paper; and
about 0.50% by weight of fragrance;
whereby the fabric defines a first surface of the liner and the silicone treated release paper defines a second surface of the liner.

15. The liner of claim 14 wherein each of the fabric material, polyester film material, adhesive, and silicone treated release paper comprise substantially similar surface areas.

16. A liner comprising:
a first layer comprising a synthetic fabric of about 9.50 gsm and a cellulosic material of about 47.0 gsm;
a second layer comprising a polyethylene film material of about 14.0 gsm;
a third layer comprising an adhesive; and
a fragrance infused within at least the first layer;
wherein the liner comprises about 24.5% by weight of said adhesive.

17. The liner of claim 16 comprising a backing member releasably adhered to the third layer.

18. The liner of claim 16 wherein the layers comprise substantially similar surface areas.

19. A method of localizing a scent of a particular strength, comprising:
obtaining a liner comprising (a) a scent absorbing amount of a non-woven fabric defining a first surface, (b) an adhesive defining a second surface, (c) a fragrance effective to produce a scent, the fragrance infused within the non-woven fabric and comprising about 0.60% by weight of said liner, whereby the first and second surfaces comprise substantially similar surface areas; and
adhering substantially the entire second surface to a target surface.

20. The method of claim 19 further comprising reinfusing the non-woven fabric with fragrance thereby restoring the scent to its original strength.

21. The method of claim 19 further comprising a means for controlling the strength of the scent by isolating the liner from the user via an odor permeable barrier.
